(19) United States
(12) Patent Application Publication
(10) Pub. No.: US 2002/0152233 A1
(43) Pub. Date: Oct. 17, 2002

(54) Apparatus and method for authoring multimedia contents with object-based interactivity

(76) Inventors: Won-Sik Cheong, Taejon (KR); Jun Geun Jeon, Seoul (KR); Kwang Yong Kim, Taejon (KR); Hyun-Cheol Kim, Taejon (KR); Myoung Ho Lee, Taejon (KR)

Correspondence Address: JACOBSON HOLMAN, PLLC., PROFESSIONAL LIMITED LIABILITY COMPANY, 400 Seventh Street, N.W., Washington, DC, 20004, US

(21) Appl. No.: 09/998,203

(22) Filed: Dec. 3, 2001

(30) Foreign Application Priority Data
Apr. 16, 2001 (KR) 2001-20237

(51) Int. Cl. G06F 7/00

(52) U.S. Cl. 707/500.1

(57) ABSTRACT

An object-based interactive multimedia contents authoring apparatus and method treats each body existing in video, audio and static images as one object to provide various editing/authoring functions for object-based interactive multimedia contents, to re-edit edited/authored results, and to execute interactive manipulation on an object basis to thereby edit user interactivity. For the purpose, the apparatus includes a user interfacing unit for providing an interface to edit object-based interactive multimedia contents by using a multimedia information editing and authoring tool, an editorial information processing unit for converting the multimedia contents supplied from the user interfacing unit to the form applicable to an object-based internal material structure, storing the converted contents, and changing the form of the interactive multimedia contents information stored as the internal material structure to the file form, and a media coding and decoding unit for encoding and decoding the interactive multimedia contents information.

### FIELD OF THE INVENTION

The present invention relates to an apparatus and method for authoring multimedia contents with object-based interactivity; and, more particularly, to an object-based interactive multimedia contents authoring apparatus and method capable of authoring multimedia contents, which include media objects such as video, audio, static images, graphics, animation, character information, etc. and user interactivity of an object unit, on an object basis and re-editing the contents on the object basis, and a computer readable recording medium on which a program for implementing the method is recorded.

### BACKGROUND OF THE INVENTION

In general, video, audio and static image editing/authoring tools consider each of video, audio and static images as an independent object and provide the object with nonlinear editing functions for cutting and attaching the object at an arbitrary position and special effect functions, e.g., fade in/out.

However, in case of utilizing editing/authoring methods provided by the conventional editing/authoring tools, since each of the video, audio and static images is considered as the independent object, it is impossible to edit each of bodies existing in the video, audio and static images and to execute user interactive editing capable of showing various contents according to users' demands while the contents are displayed.

Further, although one content can be authored by using video, static images and graphic objects during editing the video, an edited/authored resulting product is generated as one video and, therefore, it is almost impossible to re-edit the edited/authored resulting product.

That is, since conventional moving image and static image authoring apparatuses only provide methods which classify the video, audio and static images into independent objects, and edit and author the independent objects, they fail to provide object-based multimedia contents authoring methods which treat each body existing in the video and static images as one object and, further, methods for editing user interactivity.

### SUMMARY OF THE INVENTION

It is, therefore, a primary object of the present invention to provide an object-based interactive multimedia contents authoring apparatus and method for treating each body existing in video, audio and static images as one object, thereby providing various editing/authoring functions for object-based interactive multimedia contents, easily reediting edited/authored results, and executing interactive manipulation on an object basis to thereby edit user interactivity through which it is possible to respond to various demands of users, and a computer readable recording medium on which a program for implementing the method is recorded.

In accordance with one aspect of the present invention, there is provided an apparatus for authoring multimedia contents with object-based interactivity, which comprises:

a user interfacing unit for providing an interface to thereby edit object-based interactive multimedia contents by using a multimedia information editing and authoring tool;

an editorial information processing unit for converting the multimedia contents supplied from the user interfacing unit on an object basis to the form applicable to an object-based internal material structure supporting the editorial information authoring, storing the converted contents, and changing the form of the interactive multimedia contents information stored as the internal material structure to the file form so as to perform an input or output process of the contents; and

a media coding and decoding unit for encoding and decoding the interactive multimedia contents information provided from the editorial information processing unit.

In accordance with another aspect of the present invention, there is provided an object-based interactive multimedia contents authoring method for use in an object-based interactive multimedia contents authoring apparatus, comprising the steps of:

securing a new internal material structure and a new authoring space on a user interface, and receiving a plurality of parameters or initializing the authoring space to preset defaults;

authoring object-based interactive multimedia contents by inserting and deleting media objects based on the initialized authoring space and editing the user interactivity on an object basis and properties of objects; and

storing the authored object-based interactive multimedia contents in a binary or text form.

In accordance with still another aspect of the present invention, there is provided a computer readable medium on which a program used in implementing an object-based interactive multimedia contents authoring apparatus employing a processor is recorded, comprising:

a first function for securing a new internal material structure and a new authoring space on a user interface, and receiving a plurality of parameters or initializing the authoring space to preset defaults;

a second function for authoring object-based interactive multimedia contents by inserting and deleting media objects based on the initialized authoring space and editing the user interactivity on an object basis and properties of objects; and

a third function for storing the authored object-based interactive multimedia contents in a binary or text form.

### BRIEF DESCRIPTION OF THE DRAWINGS

The above and other objects and features of the present invention will become apparent from the following description of preferred embodiments given in conjunction with the accompanying drawings, in which:

FIG. 1 shows a block diagram of an object-based interactive multimedia contents authoring apparatus in accordance with an embodiment of the present invention;

FIG. 2 illustrates a detailed block diagram of an editorial information processing unit in FIG. 1;

FIG. 3 is a detailed block diagram of an object editorial information processor in FIG. 2;

FIG. 4 provides a detailed block diagram of a media coding/decoding unit in FIG. 1; and

FIG. 5 represents a flow chart of showing an object-based interactive multimedia contents authoring method in accordance with an embodiment of the present invention.

### DETAILED DESCRIPTION OF THE PREFERRED EMBODIMENTS

Hereinafter, with reference to the drawings, a preferred embodiment of the present invention will be explained in detail.

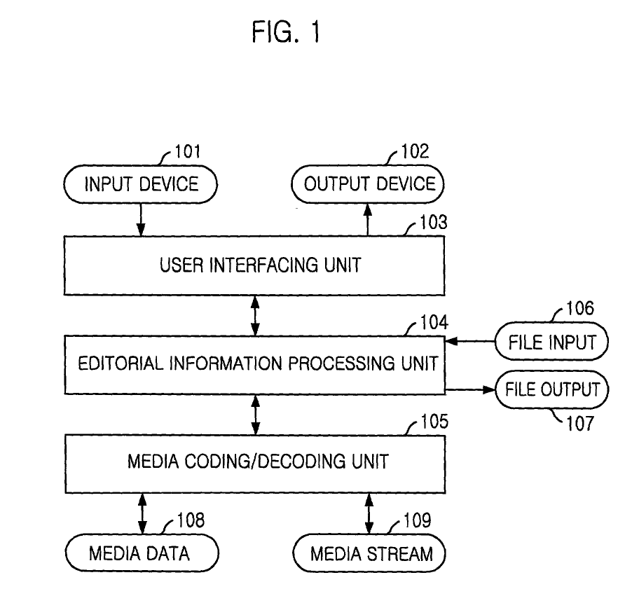

Referring to FIG. 1, there is illustrated a block diagram of an object-based interactive multimedia contents authoring apparatus in accordance with an embodiment of the present invention.

As shown in FIG. 1, the inventive interactive multimedia contents authoring apparatus comprises a user interfacing unit 103 for providing an interface through which users can easily manipulate editing/authoring tools, an editorial information processing unit 104 for editing contents and user inputs and a media coding/decoding unit 105 for coding and decoding edited/authored multimedia contents.

The user interfacing unit 103 analyzes and processes the user inputs provided through an input device 101, provides the editorial information processing unit 104 with editorial information, and displays edited/authored results through an output device 102.

Herein, the user interfacing unit 103 includes an interface for inserting and deleting each object and editing properties of characterizing each object, an interface for editing logical relationships between media objects, an interface for editing the time allocation such as a display starting time and a display ending time of each object, an interface for editing the spatial allocation determining a position of each media object in contents, an interface for editing user interactivity and an interface for showing information for the contents.

Each of the interfaces consists of an interface having a graphic user interface (GUI) form capable of simply editing properties of media objects by using a mouse and an interface for editing exact values by using a keyboard. Herein, the properties characterizing each media object represent characteristic properties of the media object, e.g., a shape of the media object, and the logical relationship between media objects is a property representing grouping information, a dependent relationship between media objects and so on.

The user interactivity means that the users can freely manipulate positions, display starting times and display ending time of the media objects during displaying the edited/authored interactive multimedia contents. At this time, the users can select, watch or listen to contents what they want and, according to requests of the users, it is possible to execute scene change, scene update, scene insertion or scene removal.

The editorial information processing unit 104 performs a function for storing the user inputs provided from the user interfacing unit 103 and the information for the media objects used in the contents editing/authoring in an internal material structure and preserving editing/authoring information for stored contents as files having a text type and a binary type and a function for reading in the editing/authoring information for the contents stored as the files of the text type and the binary type and storing the editing/authoring information in the internal material structure to make the information re-editable.

The media coding/decoding unit 105 implements a media coding/decoding technique following an international standard or a non-standardized coding/decoding technique so as to use various types of media objects including video objects of arbitrary shapes in the contents editing/authoring.

Herein, it is preferable that the media coding/decoding unit 105 includes hardware dedicated for performing media processing, thereby executing the media coding/decoding function in real-time or a higher speed than real-time.

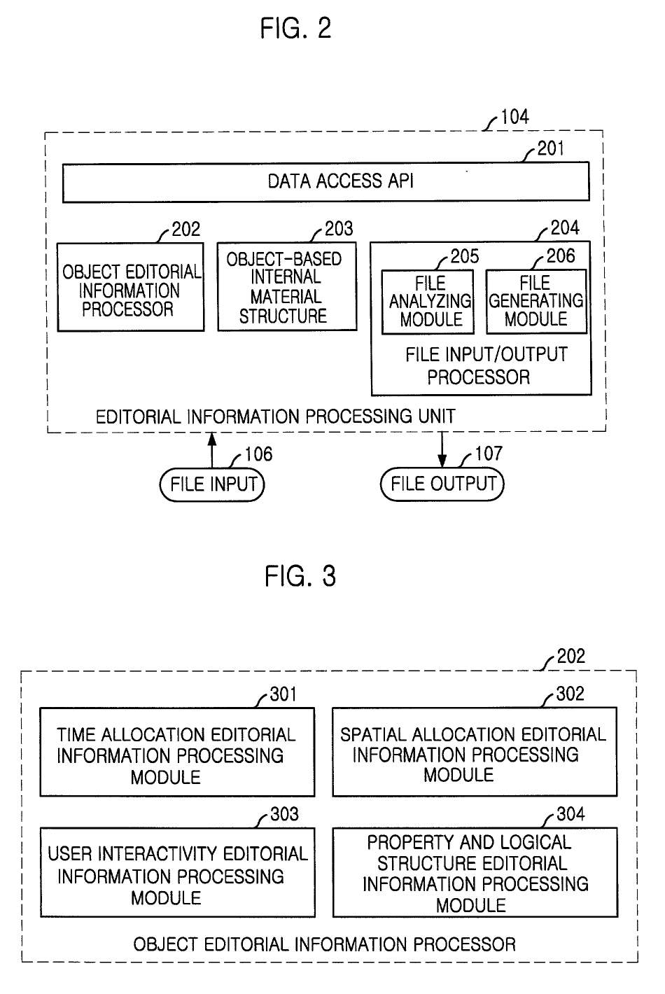

Referring to FIG. 2, there is shown a detailed block diagram of the editorial information processing unit 104 in FIG. 1 in accordance with an embodiment of the present invention.

As illustrated in FIG. 2, the editorial information processing unit 104 includes a data access application program interface (API) 201 in charge of exchanging information with the user interfacing unit 103, an object editorial information processor 202 for converting editorial information delivered from the outside to the form of being applicable to the internal material structure and then storing the converted editorial information as internal materials, an object-based internal material structure 203 for storing the editing/authoring information of the object-based interactive multimedia contents therein and a file input/output processor 204 for performing data inputting and outputting 106 and 107 of the edited/authored results related to a storage and executing a form conversion between the internal material structure and the input/output files.

The data access API 201 restricts the access from the outside to the internal material structure 203 to be accomplished therethrough.

The object-based internal material structure 203 reads in the contents stored in the storage, stores them as internal materials, and preserves the editing/authoring information provided from the outside as the internal materials so as to edit/author current contents. Here, in performing the contents editing/authoring process, there may be some users who want to author what they are aiming at by themselves in a higher level and assign a lower level process to editing/authoring tools. On the other hand, there may exist users who want to edit even details of the contents, e.g., frames in video editing, by themselves. That is, some users may want to edit the contents in an expert level.

Therefore, according to the purpose in use, the object-based internal material structure 203 can have an internal material structure supporting the lower level authoring for the general public who does not have expert knowledge about the object-based interactive multimedia contents authoring, an internal material structure supporting the higher level authoring for experts, or both of the above two internal material structures.

As an example of the internal material structure for the higher level authoring, there is O-profile of XMT (extensible MPEG-4 Textual format; ISO/IEC 14496-1 Amd3) of MPEG-4 systems. On the other hand, as the internal material structure for the lower level authoring, there is an internal material structure supporting A-profile of XMT.

The file input/output processor 204 includes a file analyzing module 205 for reading in the object-based interactive multimedia contents stored in the storage and storing the contents in the object-based internal material structure 203 and a file generating module 206 for transferring edited/authored results of the object-based interactive multimedia contents stored in the object-based internal material structure 203 to the storage.

The file input/output processor 204 further includes a form converting module so as to perform form conversion between the internal materials and the input/output files.

When being stored in the storage, the interactive multimedia contents being edited/authored resulting products can be stored in a text form noticeable by people to thereby effectively represent an intention of an author and perform easy re-editing of the contents. Furthermore, the interactive multimedia contents can be stored in a binary form so as to reduce an amount of data to be stored, accomplish easy distribution to final users of the contents and perform streaming. Therefore, it is preferable that the file input/output processor 204 supports both of the text file form and the binary file form.

The file analyzing module 205 executes a function for reading in the contents of the text form stored in the storage and storing them in the object-based internal material structure 203, a function for reading in the contents of the binary form stored in the storage and storing them in the object-based internal material structure 203, or reading in both of the contents of the text form and the contents of the binary form and storing them in the object-based internal material structure 203. Meanwhile, as occasion demands, the file analyzing module 205 can have a function for reading in the contents stored in the storage and examining logical errors and errors on the meaning of the contents.

The file generating module 206 performs a function for preserving the contents stored in the object-based internal material structure 203 in the storage in the text form or the binary form, or a function for storing the contents in the storage in the text form and the binary form. The form converting module converts the results of the higher level authoring to those of the lower level authoring in case of the editing/authoring tool providing both of the higher level editing and the lower level editing and changes the edited/authored contents to a file form of a higher level which is not supported by the editing/authoring tool.

Referring to FIG. 3, there is provided a detailed block diagram of the object editorial information processor 202 in FIG. 2 in accordance with an embodiment of the present invention.

The object editorial information processor 202 executes a function for examining whether the editorial information supplied from the outside is proper or not, a function for generating, deleting or changing the internal material structure for each media object to store the editorial information as the internal material structure and a function for converting the information stored in the internal material structure to the form that the outside can refer to.

As described in FIG. 3, the object editorial information processor 202 includes a time allocation editorial information processing module 301 for processing the editorial information for the time allocation of each media object, a spatial allocation editorial information processing module 302 for processing the editorial information for the spatial allocation of each media object, a user interactivity editorial information processing module 303 for processing the editorial information for the user interactivity and a property and logical structure editorial information processing module 304 for processing the editorial information for properties characterizing each media object, e.g., a shape of each media object.

The object editorial information processor 202 further includes an object description information processing module for converting object description information stored in the internal material structure to the form that the outside can refer to and the object description information processing module uses MPEG-7 based object description.

The time allocation editorial information processing module 301 examines whether time allocation editorial information supplied from the outside is proper or not in order to edit the time allocation information such as a display starting time and a display ending time of each media object existing in the contents when the object-based interactive multimedia contents being the edited/authored resulting products are displayed, stores the time allocation editorial information as internal materials and converts time allocation editorial information stored in the internal material structure to the form that the outside can refer to.

The spatial allocation editorial information processing module 302 examines whether the spatial allocation editorial information supplied from the outside is proper or not so as to determine a spatial position of each media object existing in the contents, stores the spatial allocation editorial information as internal materials and converts the spatial allocation editorial information stored in the internal material structure to the form that the outside can refer to.

The user interactivity editorial information processing module 303 examines whether the user interactivity editorial information supplied from the outside is proper or not to edit the user interactivity so as to provide information what the users want in response to requests of users which are inputted in the form of a mouse click, a mouse touch, a keyboard input, etc., for each media object when the object-based interactive multimedia contents are displayed, stores the user interactivity editorial information as internal materials and converts the user interactivity editorial information stored in the internal material structure to the form that the outside can refer to.

The property and logical structure editorial information processing module 304 examines whether the editorial information supplied from the outside is proper or not so as to edit a logical structure such as a property determining a shape of each media object, a dependent relationship between media objects, grouping information of media objects, etc., stores the editorial information as internal materials and converts the editorial information stored in the internal material structure to the form that the outside can refer to.

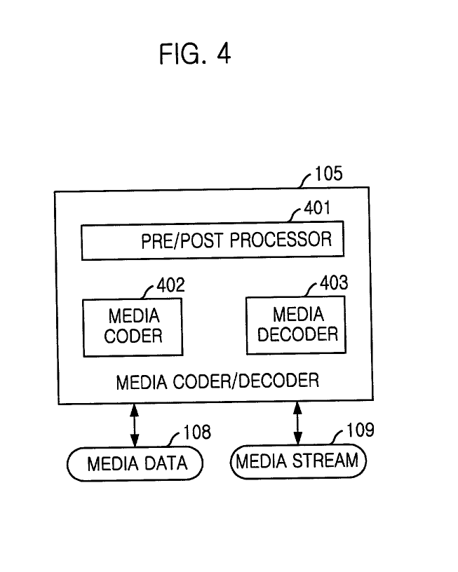

Referring to FIG. 4, there is provided a detailed block diagram of the media coding/decoding unit 105 in FIG. 1 in accordance with an embodiment of the present invention.

A pre/post processor 401 performs a function for converting various types of audio/video data to an editable type and a function for automatically or semi-automatically dividing each body existing in the video and static images.

A media coder 402 encodes media data such as video, audio and static images by using a standardized coding technique, e.g., MPEG, JPEG and so on, or a non-standardized coding technique to thereby produce a media stream.

A media decoder 403 decodes a media stream encoded by the standardized coding technique or the non-standardized coding technique to thereby reproduce media data.

Herein, the media coder 402 and the media decoder 403 should be capable of encoding and decoding media objects of the video and static images with an arbitrary shape, respectively, and they further contain a media processing accelerator in charge of performing a media coding/decoding function on a hardware accelerator in real-time or a higher speed than real-time in case there is hardware dedicated for the media processing in the system.

Moreover, the media coder 402 includes more than one video coder and at least one audio coder, wherein the video coder encodes video data based on a standardized video coding technique or a non-standardized video coding technique to thereby generate a video stream and the audio coder encodes audio data based on a standardized audio coding technique or a non-standardized audio coding technique to thereby produce an audio stream. Like the media coder 402, the media decoder 403 also contains more than one video decoder and at least one audio decoder, wherein the video decoder decodes a coded video stream which was encoded based on the standardized video coding technique or the non-standardized video coding technique to thereby reproduce video data and the audio decoder decodes a coded audio stream which was encoded based on the standardized audio coding technique or the non-standardized audio coding technique to thereby reconstruct audio data.

As an example of the video coding/decoding technique, there is a coding/decoding technique following MPEG-4 video standard (ISO/IEC 14496-2), which is capable of coding and decoding video objects of an arbitrary shape. The audio coder and decoder employ an audio coding/decoding technique satisfying MPEG-4 audio standard (ISO/IEC 14496-3).

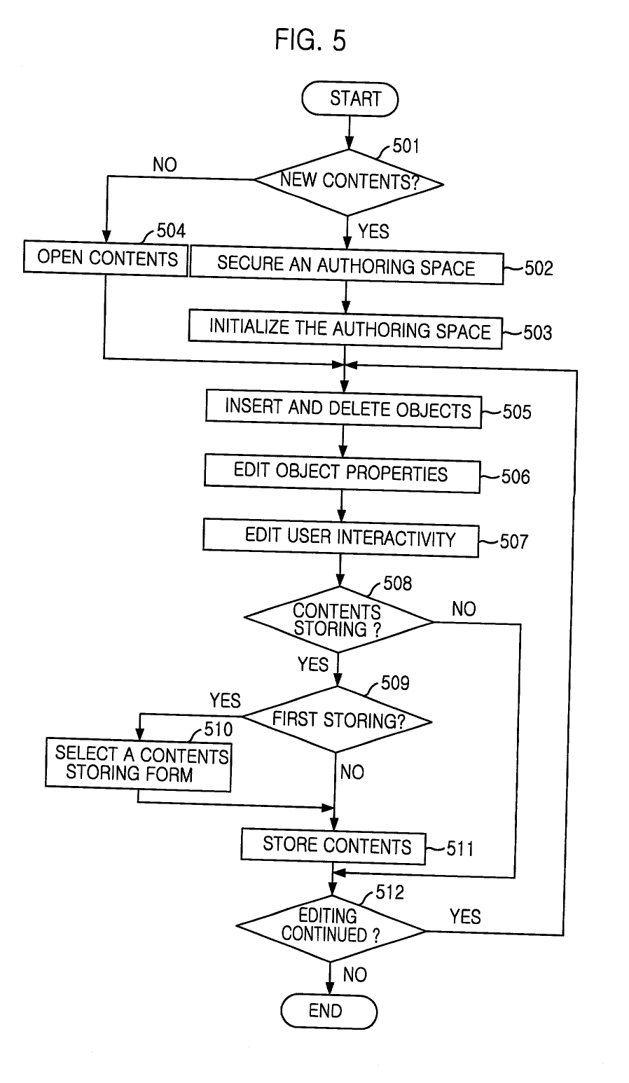

FIG. 5 represents a flow chart of showing an object-based interactive multimedia contents authoring method in accordance with an embodiment of the present invention.

In step 501, it is determined whether a user authors new contents or edits pre-authored contents, i.e., whether current contents are new.

As a result of step 501, if the current contents are determined as the new contents, there is secured in step 502 an authoring space for authoring the new contents, i.e., a new internal material structure and a new authoring space on a user interface.

Then, in step 503, the authoring space is initialized. That is, various parameters to be used in securing the authoring space are inputted by the user or determined as preset defaults.

Sequentially, this procedure goes to step 505 in which media objects required in the contents authoring and editing are inserted and unnecessary contents are deleted.

As the result of step 501, if it is determined that the current contents are not the new contents, in step 504, contents in the binary file form or the text file form are read in when the pre-authored contents are opened and, then, this procedure proceeds to step 505.

After inserting or deleting media objects required in editing/authoring the current contents in step 505, the spatial allocation and time allocation information for each media object existing in the contents and properties characterizing each media object are edited in step 506 and the user interactivity is edited on the object basis in step 507.

In the above, a processing sequence of steps 505, 506 and 507 can be changed depending on a selection of the user and those steps can be repeatedly performed according to a request of the user.

In step 508, it is checked whether the contents edited during executing the authoring process are to be stored or not.

As a result of step 508, if it is determined that the contents are not to be stored, this procedure goes to step 512 in which it is determined whether continuously performing the editing process or not. On the other hand, if it is decided that the contents are to be stored, in step 509, it is checked whether this is a first storing process of the contents or not.

As a result of step 509, if it is determined that the storing is the first time for the contents, a storing form of the contents is selected as the binary or text form in step 510. If otherwise, the contents are to be stored in its original form in step 511.

The editing process of steps 505 to 511 is repeatedly performed until it is determined in step 512 that the contents editing is completed. If the above editing and authoring process is completed, the editing procedure is terminated.

The above methods in accordance with the present invention can be implemented as computer programs which can be recorded on a computer readable recording medium such as CDROM, RAM, ROM, floppy disk, hard disk, magneto-optical disk, etc.

The present invention can obtain following advantages by providing an AV contents authoring apparatus and method capable of executing interactive manipulation on an object basis required in the object-based interactive multimedia contents authoring employed in integrated data broadcasting, interactive broadcasting, Internet broadcasting and so on.

First, it is possible to carry out the user interactive editing capable of providing desired information on the media object basis in response to requests of users.

Second, in authoring the object-based interactive multimedia contents, it is possible to execute the editing/authoring process in which a body existing in a video, audio and static image is treated as one object, which is not supported by the conventional editing/authoring tools.

Third, the video and static image object with an arbitrary shape can be used in the contents editing/authoring process.

As a result, it is come true to develop the object-based multimedia contents editing/authoring technique and to accomplish the spread of various types of digital broadcasting services.

While the present invention has been described with respect to the particular embodiments, it will be apparent to those skilled in the art that various changes and modifications may be made without departing from the spirit and scope of the invention as defined in the following claims.

What is claimed is:

1. An apparatus for authoring multimedia contents with object-based interactivity, which comprises:
a user interfacing means for providing an interface to thereby edit object-based interactive multimedia contents by using a multimedia information editing and authoring tool;
an editorial information processing means for converting the multimedia contents supplied from the user interfacing means on an object basis to the form applicable to an object-based internal material structure supporting the editorial information authoring, storing the converted contents, and changing the form of the interactive multimedia contents information stored as the internal material structure to the file form so as to perform an input or output process of the contents; and
a media coding and decoding means for encoding and decoding the interactive multimedia contents information provided from the editorial information processing means.

2. The apparatus as recited in claim 1, wherein the user interfacing means includes:
an interface for inserting or deleting media objects and editing properties characterizing each media object;
an interface for editing a logical relationship between the media objects;
an interface for editing the spatial allocation for the media objects;
an interface for editing the time allocation for the media objects;
an interface for editing the user interactivity for the media objects; and
an interface for displaying information for media objects under editing.

3. The apparatus as recited in claim 2, wherein the user interactivity means that a user can manipulate a position of a media object, a display starting time of the media object and a display ending time of the media object during displaying edited and authored interactive multimedia contents.

4. The apparatus as recited in claim 1, wherein the user interfacing means is implemented by an interface capable of editing exact values by utilizing a keyboard, a graphic user interface (GUI), or both of said two interfaces.

5. The apparatus as recited in claim 1, wherein the editorial information processing means includes:
a data access application program interface for performing information exchange with the user interfacing means;
an object editorial information processor for converting the multimedia editorial information supplied from the outside to the form applicable to the internal material structure and storing the converted multimedia editorial information;
an object-based internal material structure for reading in the object-based interactive multimedia contents stored in a storage to thereby preserve said contents as internal materials, and storing editing and authoring information inputted from the outside as internal materials to thereby edit and author current contents; and
a file input and output processor for performing an input and output process of edited and authored results related to the storage and carrying out the form conversion between the internal materials and input and output files.

6. The apparatus as recited in claim 5, wherein the object editorial information processor contains:
a time allocation editorial information processing module for processing editorial information related to the time allocation of each media object;
a spatial allocation editorial information processing module for processing editorial information for the spatial allocation of each media object;
a user interactivity editorial information processing module for processing editorial information for the user interactivity; and
a property and logical structure editorial information processing module for processing editorial information for properties characterizing each media object.

7. The apparatus as recited in claim 6, wherein the object editorial information processor further contains an object description information processing module for examining whether information for managing and searching media objects is proper or not, storing said information as internal materials and converting the object description information stored in the internal material structure to the form that the outside can refer to.

8. The apparatus as recited in claim 6, wherein the object editorial information processor performs the editorial information processing for a higher level authoring, a lower level authoring and the higher and lower level authoring.

9. The apparatus as recited in claim 5, wherein the object-based internal material structure supports internal materials for a higher level authoring, those for a lower level authoring and those for the higher and lower level authoring.

10. The apparatus as recited in claim 5, wherein the file input and output processor contains:
a file analyzing module for reading in the object-based interactive multimedia contents stored in the storage, storing the contents in the object-based internal material structure and examining errors of the contents by analyzing the contents; and
a file generating module for transferring edited and authored results of the object-based interactive multimedia contents stored in the object-based internal material structure to the storage.

11. The apparatus as recited in claim 10, wherein the file input and output processor further contains a form converting module for performing the form conversion between the internal material structure and the input and output form.

12. The apparatus as recited in claim 11, wherein the form converting module changes a higher level authoring result to a lower level authoring result when the editing and authoring tool provides the higher and lower level authoring, and converts the edited and authored contents to the higher level file form which is not supported by the editing and authoring tool.

13. The apparatus as recited in claim 1, wherein the media coding and decoding means includes:
a pre-post processor for performing a prior process and a post process required for the media coding and decoding;
a media coder for encoding media data so as to produce a media stream; and
a media decoder for decoding a media stream to reproduce media data.

14. The apparatus as recited in claim 13, wherein the media coder or decoder further contains a media processing accelerator, which is hardware, dedicated for performing the media coding and decoding in real-time or a higher speed than real-time.

15. An object-based interactive multimedia contents authoring method for use in an object-based interactive multimedia contents authoring apparatus, comprising the steps of:
securing a new internal material structure and a new authoring space on a user interface, and receiving a plurality of parameters or initializing the authoring space to preset defaults;
authoring object-based interactive multimedia contents by inserting and deleting media objects based on the initialized authoring space and editing the user interactivity on an object basis and properties of objects; and
storing the authored object-based interactive multimedia contents in a binary or text form.

16. A computer readable medium on which a program used in implementing an object-based interactive multimedia contents authoring apparatus employing a processor is recorded, comprising:
first program instruction means for securing a new internal material structure and a new authoring space on a user interface, and receiving a plurality of parameters or initializing the authoring space to preset defaults;
second program instruction means for authoring object-based interactive multimedia contents by inserting and deleting media objects based on the initialized authoring space and editing the user interactivity on an object basis and properties of objects; and
third program instruction means for storing the authored object-based interactive multimedia contents in a binary or text form.
